(19) United States
(12) Patent Application Publication
(10) Pub. No.: US 2009/0262541 A1
(43) Pub. Date: Oct. 22, 2009

(54) METHOD AND APPARATUS FOR LIGHT FIXTURE

(75) Inventor: Norman L. Rogers, Miami, FL (US)

Correspondence Address: HEIMLICH LAW, 5952 DIAL WAY, SAN JOSE, CA, 95129, US

(73) Assignee: Miami Green Licensing, LLC, Miami, FL (US)

(21) Appl. No.: 12/424,485

(22) Filed: Apr. 15, 2009

Related U.S. Application Data
(60) Provisional application No. 61/046,423, filed on Apr. 19, 2008.

(51) Int. Cl. F21V 21/16; F21V 21/02

(52) U.S. Cl. 362/368

(57) ABSTRACT

A method and apparatus for light fixture have been disclosed.

### RELATED APPLICATION

This patent application claims priority of U.S. Provisional Application Ser. No. 61/046423 filed Apr. 19, 2008 titled “Method And Apparatus For Light Fixture”, which is hereby incorporated by reference in its entirety.

### FIELD OF THE INVENTION

The present invention pertains to lighting. More particularly, the present invention relates to a method and apparatus for light fixture.

### BACKGROUND OF THE INVENTION

Lighting is useful to illuminate areas and objects.

Many houses, businesses, rooms in houses, etc. do not have dedicated in wall or in ceiling lighting. As a result desk lamps and torchieres (also called floor lamps) are often used. These lamps and torchieres are subject to being knocked over or bumped into which may lead to injuries and/or fires. This may present a problem.

### BRIEF DESCRIPTION OF THE DRAWINGS

The invention is illustrated by way of example and not limitation in the figures of the accompanying drawings in which:

FIG. 1A illustrates one embodiment of the invention showing a side view;

FIG. 1B illustrates one embodiment of the invention showing a front view;

FIG. 1C illustrates one embodiment of the invention showing a front view;

FIG. 2 illustrates a common picture hook upon which embodiments of the invention may be hung;

FIG. 3 illustrates one embodiment of the invention showing a section of the light fixture;

FIG. 4 illustrates one embodiment of the invention showing a front view of the fixture;

FIG. 5 illustrates how one embodiment of the invention may be hung from picture hooks;

FIG. 6 illustrates one embodiment of the invention showing how the flexible cable is pulled though;

FIG. 7 illustrates one embodiment of the invention showing how the flexible cable may be routed over the hook;

FIG. 8 illustrates one embodiment of the invention showing the use of stops;

FIG. 9 illustrates one embodiment of the invention showing how the cable stop engages;

FIG. 10 illustrates embodiments of conditions of the present invention;

FIG. 11 illustrates one embodiment of the invention in which the access holes are located lower;

FIG. 12 illustrates various techniques as implemented in various embodiments;

FIG. 13 illustrates one embodiment of the invention showing a break-away power connection;

FIG. 14 illustrates one embodiment of the invention showing the cord not under tension;

FIG. 15 illustrates one embodiment of the invention showing the cord under tension;

FIG. 16 shows one embodiment of the invention showing the fixture;

FIG. 17 shows one embodiment of the invention viewed from an end cap;

FIG. 18 illustrates one embodiment of the invention showing the back of the fixture;

FIG. 19 illustrates one embodiment of the invention to achieve center of gravity near the center;

FIG. 20 illustrates one embodiment of the present invention;

FIG. 21 illustrates one embodiment of the invention showing a counterweight;

FIG. 22 illustrates one embodiment of the invention showing a counterweight locking location; and

FIG. 23 illustrates one embodiment of the invention in flow chart form.

### SUMMARY OF THE INVENTION

Applicant hereby submits that this Summary of the Invention complies with applicable CN (China i.e. SIPO) standards. All claims are literally copied here.
1. An apparatus comprising:

a fixture, said fixture having a first surface, said first surface having a first cable anchor point and a second cable anchor point, said first surface having a first cable viewing hole and a second cable viewing hole; and

a cable having a first end and a second end, said cable first end attached to said first cable anchor point and said cable second end attached to said second cable anchor point, and said first cable viewing hole located proximate to said first cable anchor point, and said second cable viewing hole located proximate to said second cable anchor point such that a first portion of said cable is viewable through said first cable viewing hole and a second portion of said cable is viewable said second cable viewing hole.
2. The apparatus of claim 1 further comprising one or more cable guides, said one or more cable guides fixedly attached to said first surface and located between said first cable viewing hole and said second cable viewing hole.
3. The apparatus of claim 2 further comprising one or more cable stops fixedly attached to said cable and preventing further movement of said cable when said one or more cable stops is in contact with said one or more cable guides.
4. The apparatus of claim 2 wherein said one or more cable guides are said fixedly attached such that said cable is substantially horizontal between said one or more cable guides when a top edge of said fixture is substantially horizontal.
5. The apparatus of claim 1 further comprising a counterweight attached to said fixture wherein said attached counterweight moves the center of gravity of said fixture with respect to said fixture with said attached counterweight versus said fixture alone.
6. The apparatus of claim 5 further wherein said counterweight compensates for a weight of a fluorescent ballast attached to said fixture.
7. The apparatus of claim 6 further wherein said counterweight is angled.
8. The apparatus of claim 1 further comprising a power cord, said power cord having a break away electrical connection.
9. The apparatus of claim 1 further comprising a suspension system for said break away electrical connection such that pulling on said power cord aligns said break away electrical connection along an axis of force of said pulling on said power cord.
10. The apparatus of claim 9 wherein said suspension system further comprises a retraction mechanism such that said break away electrical connection is retracted within said fixture when said power cord is not pulled, and said break away electrical connection emerges from an edge of said fixture when said power cord is pulled.
11. The apparatus of claim 1 further comprising one or more lights, said one or more lights providing a diffuse light from one or more apertures located in said fixture onto a power cord powering said one or more lights.
12. The apparatus of claim 1 further comprising a power cord, said power cord having a sinuous shallow spiral curve.
13. A method for hanging a fixture on one or more hooks, said fixture having one or more viewing holes, and said fixture having a cable, the method comprising:

positioning said cable over said one or more hooks by viewing through one or more viewing holes.
14. The method of claim 13 wherein said fixture is raised by pulling said cable away from said fixture and said fixture is secured at a height by securing said cable to said fixture.
15. The method of claim 14 wherein said securing said cable to said fixture further comprises hooking one looped end of said cable over a slot in said fixture.
16. An apparatus comprising:

a wall mountable fixture, said wall mountable fixture having a first surface locatable proximate to a wall having one or more hooks from which said wall mountable fixture can hang;

said first surface having a cable assembly, said cable assembly having a cable having a first cable end and a second cable end;

said cable extending above said wall mountable fixture by an distance denoted as FDAF (full distance above fixture) when said first cable end and said second cable end are not secured to said wall mountable fixture.
17. The apparatus of claim 16 further comprising one or more securing points located on said wall mountable fixture, said one or more securing points wherein when said first cable end is secured to said one or more securing points said cable extending above said wall mountable fixture is a distance less than FDAF.
18. The apparatus of claim 16 wherein said first cable end is formed into a first loop and further comprising one or more hooking points located on said wall mountable fixture wherein when said first loop is hooked over said one or more hooking points said cable extending above said wall mountable fixed is a distance less than FDAF.
19. The apparatus of claim 18 wherein said second cable end is formed into a second loop and wherein when said second loop is hooked over said one or more hooking points said cable extending above said wall mountable fixed is a distance less than FDAF.
20. The apparatus of claim 19 wherein said fixture further comprises a built-in level and wherein said fixture may be raised and leveled by pulling on said first loop and said second loop and then hooking said first loop and said second loop on said one or more hooking points.

### DETAILED DESCRIPTION

In one embodiment of the present invention, a light fixture is hung from two or more mountings secured to a wall. The light fixture (“fixture”) has a hanging cable that allows easy attachment to the wall mountings and allows for raising and lowering of the fixture as well as leveling the fixture. The fixture hugs the wall and provides for light to be directed toward the ceiling. A power cord with an optional in-line switch has a break-away connection mechanism so that tugging or tripping on the power cord does not tear the fixture from the wall.

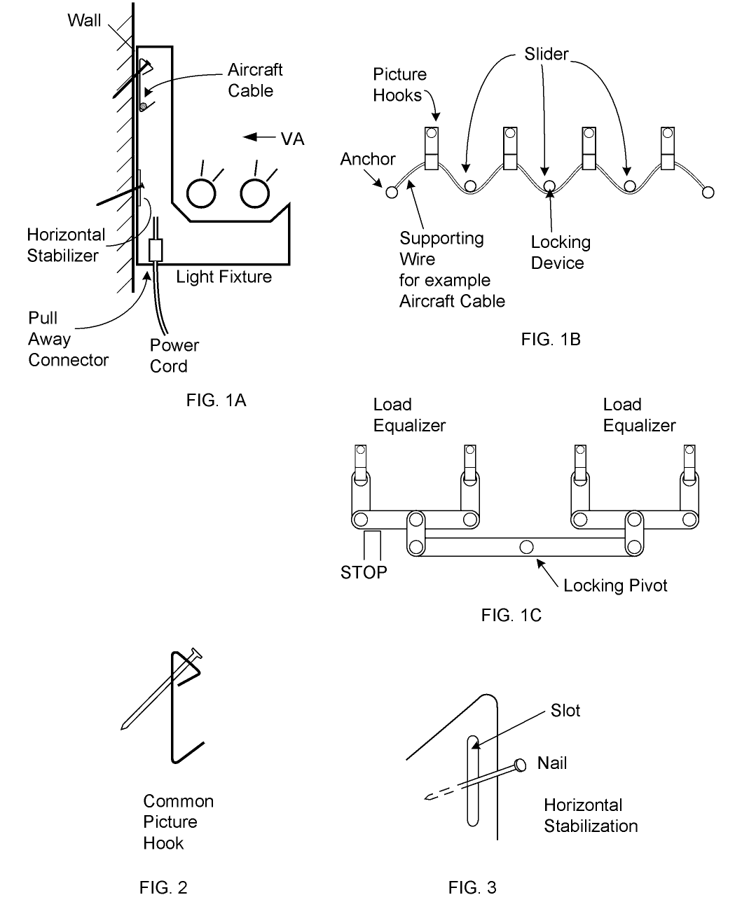

FIG. 1A illustrates one embodiment of the invention showing a side view with side panels removed and the light fixture attached to the wall. A cable, such as an aircraft cable is used to hang the light fixture on the wall. The light fixture may have a horizontal stabilizer. Also shown on the light fixture is a pull away connector on a power cord.

FIG. 1B illustrates one embodiment of the invention showing a front view (as if looking in direction VA as shown in FIG. 1A) of the mounting assembly. There are picture hooks (four shown) and a supporting wire which has an anchor (on the light fixture) and a locking device. The supporting wire, for example aircraft cable, is anchored at both ends to the light fixture (not shown). The slider points, three shown of which one has a locking device are part of the light fixture.

FIG. 1C illustrates one embodiment of the invention showing a front view (as if looking in direction VA as shown in FIG. 1A) of the mounting assembly. Here, rather than a cable as shown in FIG. 1B a series of linkages are used to provide for load equalization of the weight of the light fixture on the wall mounting points. Also shown is an optional STOP so the linkages are limited in movement. Also shown is a locking pivot on one of the linkages.

FIG. 2 illustrates a common picture hook upon which embodiments of the invention may be hung.

FIG. 3 illustrates one embodiment of the invention showing a section of the light fixture having a slot for horizontal stabilization through which a nail may be placed.

In one embodiment the invention may be a wall-mountable light fixture. This wall mounted light fixture has features that make it easy for a homeowner or apartment dweller to install the fixture, improve fixture safety and enhance the appearance of the fixture and the quality of the light. One implementation, for example as shown in FIG. 1A may use two 54 watt T5 fluorescent bulbs arranged with reflectors to place the bulk of the light on the ceiling of the room. The fixture is installed on the wall of the room by suspending it from picture hooks. The power cord plugs into the fixture and will be released if pulled hard enough to endanger the mounting security of the fixture. The power plug may be plugged into a switched socket in the room if available, and if not a switch on the fixture may be used to turn the light on and off.

In one embodiment of the invention, a light fixture is mounted on picture hooks or similar temporary anchors for suspending objects on a wall. Note that open picture hooks or safety picture hooks that trap a wire may be used.

In one embodiment of the invention, a load equalization device is used so that each of the picture hooks experiences approximately equal load, even if not well aligned. This may be accomplished, in one embodiment, by a cable that can slide over mounting points or by a system of mechanical levers and pivots as shown in FIG. 1B and FIG. 1C, for example.

In one embodiment of the invention, there is a leveling device so that the fixture can be leveled and locked in a level position either through friction or a locking device. This may be accomplished, for example, by locking the center of the sliding wire or the center pivot of the mechanical load equalization system as shown in FIG. 1B and FIG. 1C.

In one embodiment of the invention, there is a horizontal stabilizing device to aid in absorbing torques on the fixture around an axis perpendicular to the wall. This can be accomplished by a nail in a slot which resists sideways movement but not up and down movement which is resisted by the picture hooks. In one implementation the nail may be placed in the slot while a part of the fixture will drive the nail into the wall when an installer pushes the fixture toward the wall. See FIG. 3.

In one embodiment of the invention is a spring loaded triggered release of the power cord connector where it enters the fixture if the power cord is pulled in such a way to pull the bottom of the fixture away from the wall. If the power cord is pulled straight down frictional release of the connector is sufficient to prevent forcible dismounting of the fixture.

In one embodiment of the invention, in order to camouflage the power cord so as to make it less conspicuous the following measures are taken: First, the power cord may have light reflective characteristics similar to typical residential interior walls. Second, the cord and walls may be washed by diffuse light coming from apertures in the fixture arranged to nearly eliminate any tendency for the power cord to cast a shadow on the wall. Third, the power cord may hang in a sinuous shallow spiral curve, or similar way, rather than hang straight, since the human eye has greater sensitivity to straight edges than to wavy broken edges.

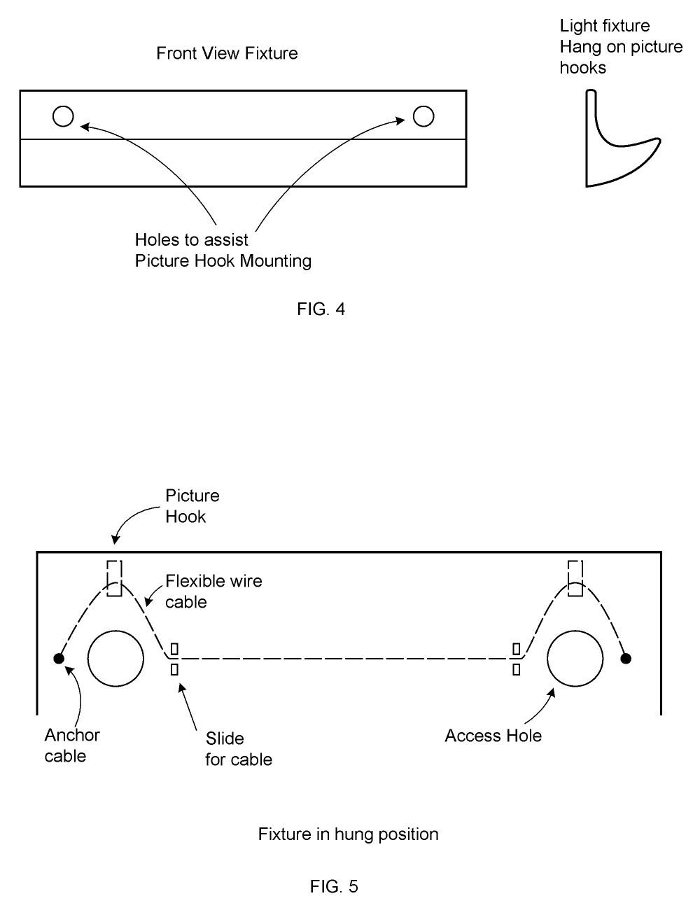

FIG. 4 illustrates one embodiment of the invention showing a front view of the fixture with holes to assist with hooking the cable, for example to a picture hook mounting. FIG. 4 also shows a side view of one embodiment of the invention as a light fixture hung on picture hooks.

FIG. 5 illustrates how one embodiment of the invention may be hung from picture hooks. Shown, starting from the left is an anchor for the cable. The flexible wire cable (shown as dashed) is hung over a picture hook which is located above an access hole, the flexible wire cable then goes through a slide for cable (part of the fixture). The flexible cable then passes through another slide for the cable located to the right which then passes over another picture hook located above an access hole and finally the cable is anchored at the far right.

In one embodiment of the invention, as shown in FIG. 4 is the overall aspect of the light fixture. Two mounting assist holes are used to aid hooking the support cable on picture hooks. The holes if located low enough on the backplate of the fixture are not visible to a person standing in the room if the fixture is mounted high enough to hide the holes behind the fixture structure. For example, in one embodiment of the invention as shown in FIG. 5 a cable is fixed with two anchors and two slides. When the cable is hooked on the picture hooks the fixture may be leveled by lifting the low side to take tension off the cable and then lowering the high side to cause the cable to slide through the picture hooks. When the cable is under tension friction against the picture hooks and slides it resists any unbalanced weight creating a rotational torque. To increase the resistance to tilting more slides and a sinuous path may be added for the cable between the two slides shown.

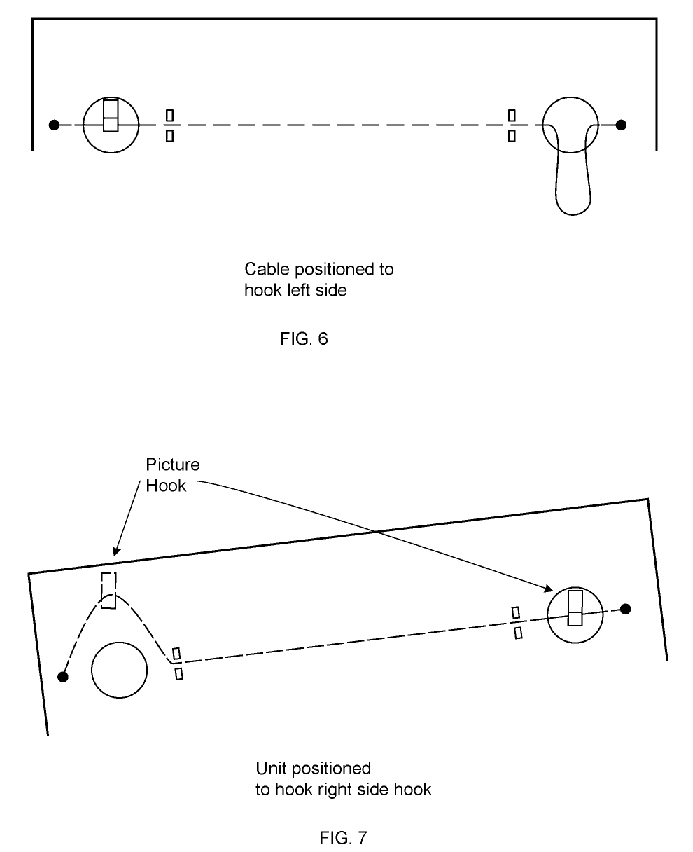

FIG. 6 illustrates one embodiment of the invention showing how the flexible cable is pulled though the rightmost access hole and thus assists in hooking the cable over the left hook through the leftmost access hole.

FIG. 7 illustrates one embodiment of the invention showing how the flexible cable once hooked over the leftmost hook (as shown in FIG. 6), the fixture may then be lowered on the left hook taking up the slack in the cable so that it may be routed over the hook on the right side through the rightmost access hole.

Thus, FIG. 6 and FIG. 7 show how the flexible cable may be easily attached in this case to two hooks through corresponding access holes. In this way the fixture may be easily attached and in reverse, removed from hooks.

In one embodiment of the invention, in order to hang the fixture the cable is pulled through one hole as shown in FIG. 6. This makes the other side of the cable visible so that it may be hooked on the picture hook. Earthquake or tremor type picture hooks may be used which have provision to trap the wire in the picture hook. To hook the other side on a picture hook the left side of the fixture is lowered until the cable appears in the right side assist hole and the other side is then hooked as shown in FIG. 7. The fixture can then be leveled as previously described. To dismount the fixture the fixture is first tilted until one side may be unhooked and the cable pulled through the hole supporting the fixture by the cable loop. Then the other side may be unhooked and the fixture supported by holding cable loops at both ends.

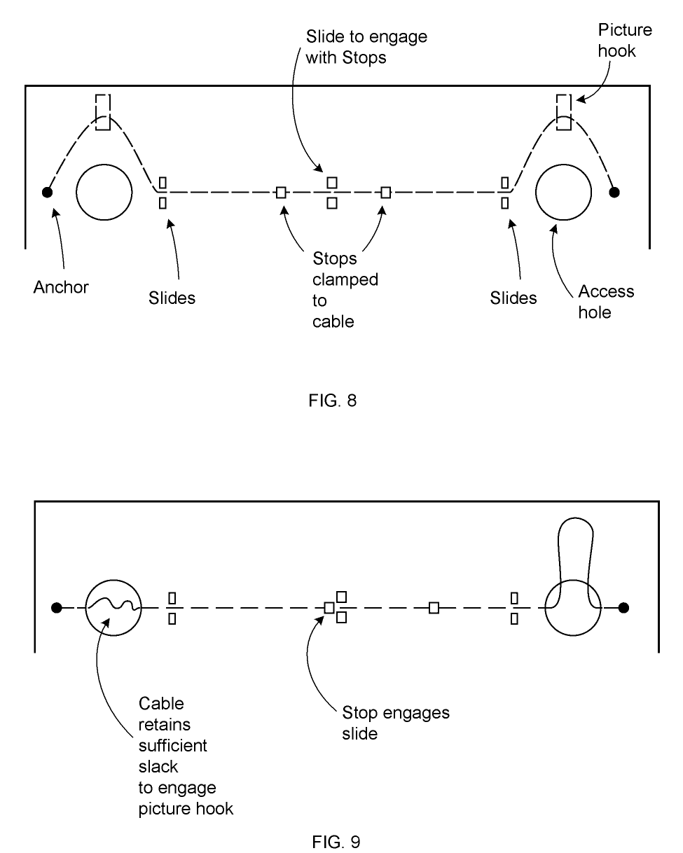

FIG. 8 illustrates one embodiment of the invention showing the use of stops which are clamped to the cable so as to limit cable movement.

FIG. 9 illustrates one embodiment of the invention showing how the cable stop engages the slide and yet the cable has sufficient slack to engage a picture hook.

In one embodiment of the invention as shown in FIG. 8 and FIG. 9 the cable can be drawn through one access hole thereby making the cable accessible in the other access hole to hook on the supporting picture hook. The picture hook may be of the type that traps the cable. However, if the cable is drawn tight across the access hole it may be difficult to hook the cable due to the recess relative to the wall relative to the anchor and slide. Thus a limited amount of slack remains in the cable so that it can be hooked in even considering the recess. To ensure a limited amount of slack an additional slide is mounted on the back of the fixture and stops are affixed to the cable to ensure that some slack remains even when the cable is pulled out of the other access hole the maximum amount. Note that the user can support the fixture by the long cable loop while mounting the fixture on the wall. The user can also support the other end of the fixture by grasping the short loop shown on the left of FIG. 9. Once one side has been hooked, that side can be lowered until a short loop remains on the other side which can then also be hooked. Then the fixture can be leveled.

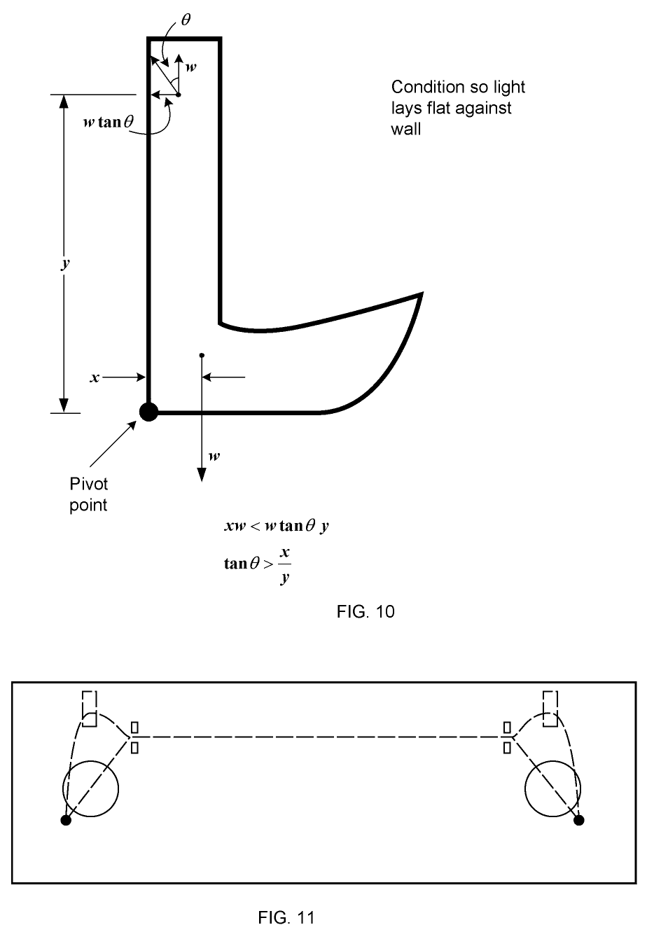

FIG. 10 illustrates embodiments of conditions of the present invention so that a light fixture lays substantially flat against a wall.

FIG. 11 illustrates one embodiment of the invention in which the access holes are located lower and closer to anchor points on the fixture.

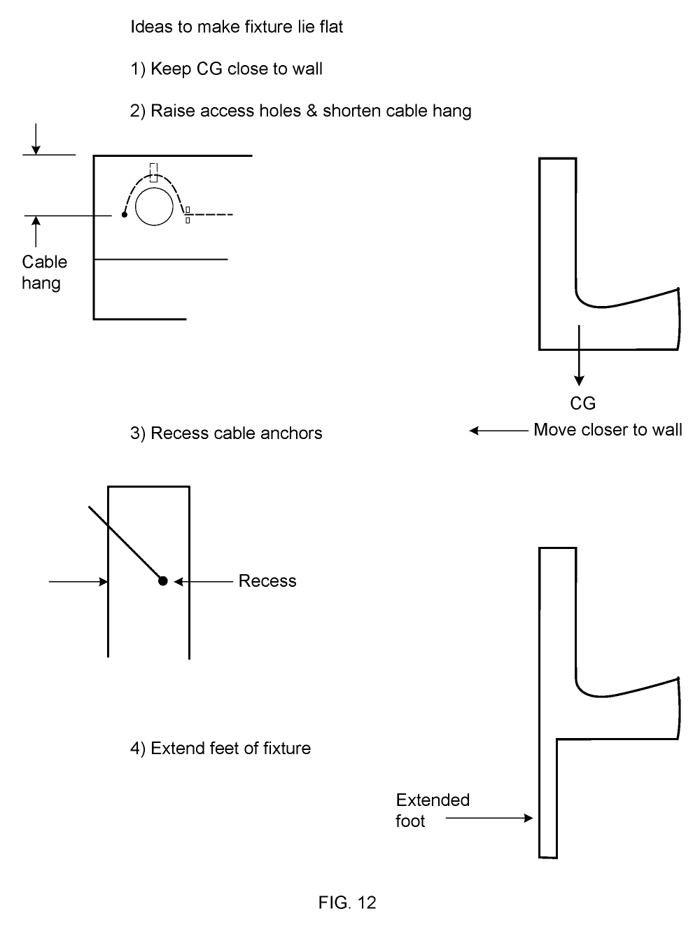

FIG. 12 illustrates various techniques as implemented in various embodiments of the invention to make a fixture lie flat. In one embodiment the center of gravity (“CG”) is close to the wall. In one embodiment recessed access holes may be used. In one embodiment shorter cable hang may be used. In one embodiment the cable anchors may be recessed. In one embodiment the fixture may have an extended foot. One of skill in the art will appreciate that any combination of the above may be used. Denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all 32 possible combinations. Applicant(s) hereby submit that the foregoing combinations comply with applicable EP (European Patent) standards. No preference is given any combination.

In one embodiment of the invention as shown in FIG. 12 in order for the light fixture to lay flat against the wall the cable anchors and slides are recessed by an amount that depends on the location of the center of gravity of the fixture and the location and length of the cables supporting the fixture.

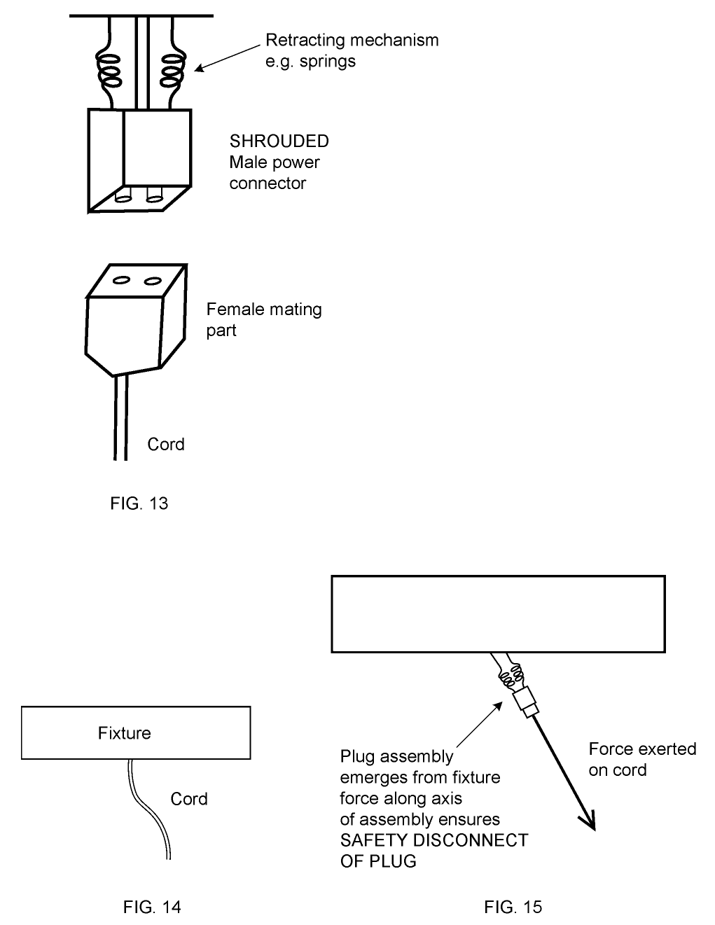

FIG. 13 illustrates one embodiment of the invention showing a break-away power connection having a cord going to the female mating port which mates with a male power receptacle which may be shrouded and where the male receptacle has a retracting mechanism (e.g. springs).

FIG. 14 illustrates one embodiment of the invention showing the cord not under tension.

FIG. 15 illustrates one embodiment of the invention showing the cord under tension.

In one embodiment of the invention, a fluorescent light fixture is suspended from a wall on picture hooks. A power cord drops from the light. It is a concern that if the cord is pulled vigorously it might pull the fixture loose from its mounting. To avoid this, mating plugs in the cord are designed in one embodiment of the invention to pull apart if excessive force is applied of the cord. If the mating plug attached to the fixture is rigidly attached then if the cord is pulled sideways the plug may not disconnect due to the binding of the plug with its mating part. However, in one embodiment of the invention the plug is attached to the fixture by a flexible cord and springs or another retraction device holds the plug assembly hidden inside a well (space) in the fixture. Now if great force is exerted on the cord the assembly will be pulled out of the fixture and the plug assembly will be aligned with the force to prevent binding. FIG. 13 illustrates one embodiment of the invention where springs represent the retraction device which may also be implemented in a variety of other ways. FIG. 14 shows the cord not under tension and the plug assembly invisibly retracted into the fixture. FIG. 15 shows the cord with force sufficient to pull the plug assembly out of its well (space) and the force aligned with the assembly.

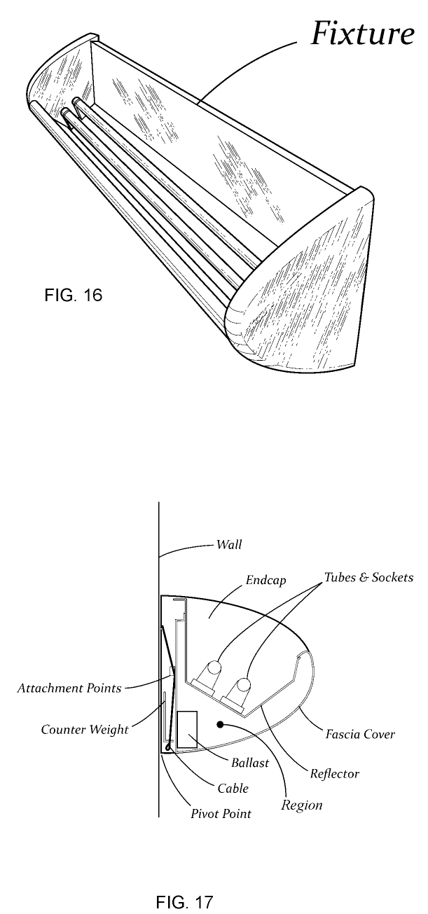

In one embodiment of the invention, it is a wall mountable light fixture that can be easily hung on the wall of a room to provide copious indirect light in a safe and efficient manner. For example as one implementation shown in FIG. 16 illustrates the implementation uses dual T5 HO fluorescent tubes to provide the light, approximately 9000 lumens. A highly reflective reflector directs the light upward so as to throw most of the light on the ceiling above the fixture or the wall on which the fixture is hung. A cover provides a decorative front surface and forms a compartment to hold a fluorescent ballast (e.g. passive or electronic). End caps at each end cover the ends of the fixture and provide mechanical support. The fixture is supported on the mounting wall by mounting devices such as, but not limited to, picture hooks or modified picture hooks that may be supported by a nail driven (or screw screwed) into drywall, plaster, wood, concrete, etc. A counterweight moves the center of gravity of the assembly closer to the wall making it possible for the assembly to lie flat against the wall without an excessive horizontal force component pulling the picture hooks away from the wall. A cable assembly slips over the picture hook style mountings. The cable can be unhooked at the bottom so that the mounting loops will extend above the reflector to facilitate mounting the assembly on the wall hooks. After the unit has been mounted it is “jacked up” (or raised) by pulling on the mounting cable ends which can then be hooked together or hooked to locations on the fixture or hooked to locations on the counterweight assembly (depending upon the embodiment) to fix the unit at a proper height or for example high enough to cover the mounting hooks so that they do not show. The fixture can be easily mounted on a wall by a homeowner or apartment dweller. It plugs into an electrical outlet, for example, in one embodiment, with an ungrounded plug to accommodate dwellings with non-grounded electrical outlets. In one embodiment, an in-cord switch allows the unit to be turned on and off, or alternately it may be plugged into an outlet that is switched by a wall switch. The electrical cord has an in-cord connector near the fixture that pulls apart if the cord is tugged hard. This is to prevent pulling the fixture off the wall by pulling on the cord.

FIG. 16 shows one embodiment of the invention showing the fixture having a back plate, a reflector, two lamps, and two end caps. The fixture (i.e. the fluorescent light fixture as illustrated) may be suspended on picture hooks or similar mounting hooks for attachment to a wall.

FIG. 17 shows one embodiment of the invention viewed from an end cap (one end cap removed) showing the fixture having a back plate mounted to a wall. There are attachment points, a counter weight, a ballast, a cable, a reflector, tubes (lamps e.g. fluorescent) and sockets, a fascia cover and the pivot point is indicated. Also shown is a region (space or well) which extends from the back plate to forward of the ballast where a power cord assembly may be placed.

As illustrated, for example, in FIG. 17, one embodiment of the invention has recessed attachment points for a cable suspension for the light fixture which allows the fixture to lie flat against the wall by ensuring that the suspension cable makes an angle with the fixture sufficient to provide a torque to counter the torque created by the center of gravity of the fixture, both torques around a pivot point at the line where the bottom of the fixture touches the mounting wall.

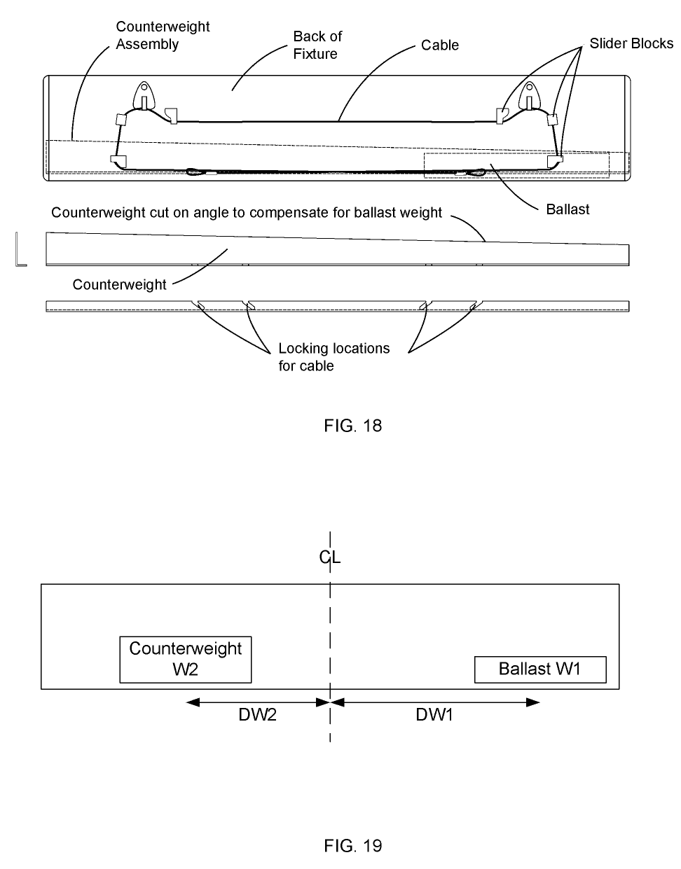

FIG. 18 illustrates one embodiment of the invention showing the back of the fixture, a cable, slider blocks, a ballast on the right, and a counterweight assembly. Also shown is the counterweight which is cut on an angle to compensate for the ballast weight so that the center of gravity is near the center of the fixture. Also shown are locking locations for the cable ends which are cut into the counterweight. In one embodiment of the invention, the counterweight assembly comprises a weight at the back of the fixture such as to move the overall center of gravity of the fixture closer to the wall and reduce the outward force on the mounting picture hooks helping to ensure that the fixture lies flat against the wall.

One of skill in the art will appreciate that there are other techniques that may be used other than cutting a counterweight at an angle to achieve a center of gravity (CG) near the centerline (CL) of a fixture. One approach would be to place a weight similar to that of the ballast a equal distance from the center line opposite to that of the ballast. FIG. 19 illustrates one embodiment of the invention showing another approach where to achieve a CG near the CL then W1*DW1 should be substantially equal W2*DW2, where W1 is the center of gravity of the ballast weight W1, DW1 is the distance from the center of gravity of the ballast weight W1 to the center line (CL) of the fixture, and where W2 is the center of gravity of the counterweight W2, and DW2 is the distance from the center of gravity of the counterweight W2 to the center line (CL) of the fixture.

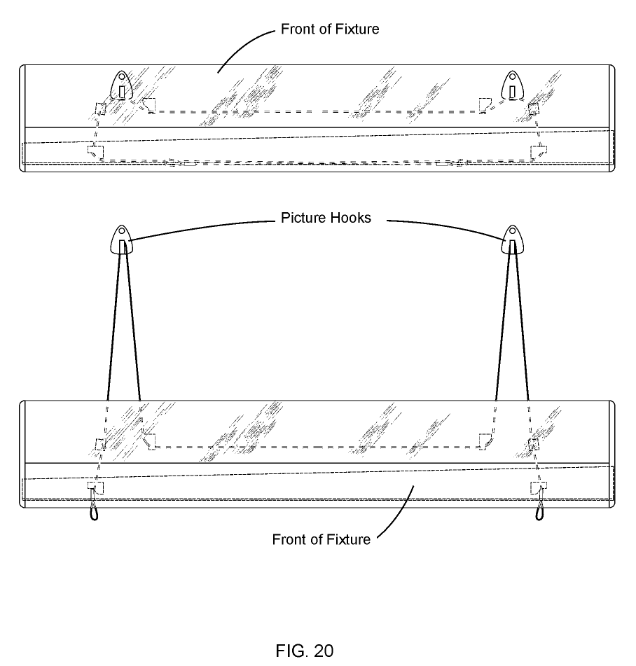

FIG. 20 illustrates one embodiment of the present invention. Shown are the fixture, the front of the fixture, and picture hooks. As illustrated in FIG. 20 the invention in one embodiment has a movable cable suspension that allows slack to be added to the cable by unhooking the ends of the cable from points on the counterweight assembly or other attachment points on the fixture. This allows the attachment loops of the cable to be extended above the edges of the fixture for easy mounting and secondarily allows the fixture to be lowered for easy cleaning or tube replacement without removing the fixture from the wall.

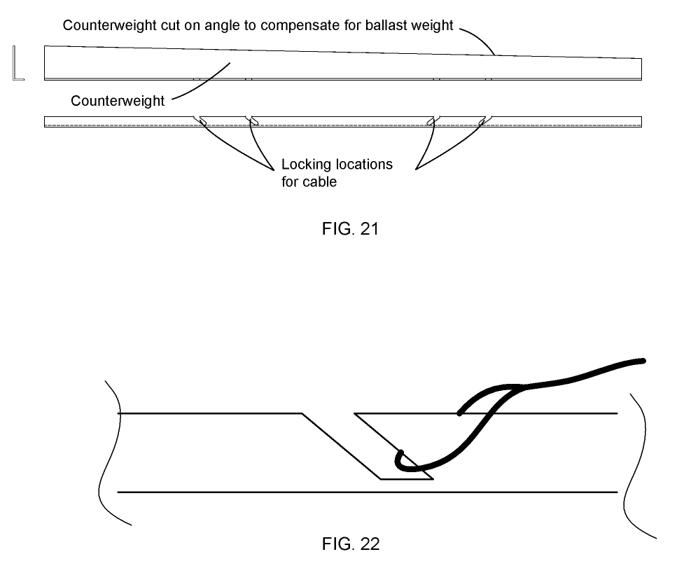

FIG. 21 illustrates one embodiment of the invention showing a counterweight which is cut on an angle so as to compensate for the ballast weight to more nearly align the center of gravity of the fixture with the fixture's centerline. Also shown are locking locations for the cable which have been cut into the counterweight. As may be seen on the orthographic views, on the left is the “L” shape of the counterweight and at the bottom is the view showing the locking positions for the cable. In one embodiment of the invention there are dual hooking points for the cable ends so that the fixture cable suspension may be reduced in length so that if the wall attachments are further from the wall in a particular instance the fixture may be pulled higher and the angle of the cable with the wall increased so as to provide more torque to force the fixture to lie flat. In such a case the wall attachments need to be able to withstand the greater outward force that will be imposed on them.

FIG. 22 illustrates one embodiment of the invention showing a counterweight locking location and a cable engaged in the locking slot.

In one embodiment of the invention, a connector on the power cord disengages if the power cord is pulled dangerously hard so as to prevent the fixture being accidentally pulled off the wall by an accidental pull on the cord. The connector may be loosely held in the space between the wall and the fixture, such as by a rubber band suspension, spring suspension, etc. or by some other device that will cause it to pop out when pulled lightly. If the cord is pulled out the connector will experience an in-line force that will promote disengagement of the connector if the force is dangerously large. One such embodiment is illustrated in FIG. 13, FIG. 14, and FIG. 15. This approach also allows for different cord sets for different countries.

In one embodiment of the invention, a power cord that is made to be inconspicuous by making it of a material that may be painted with wall paint so as to make its color match the color of the wall.

In one embodiment of the invention, an aperture in the bottom of the light fixture provides a downwash light in such a manner as to render inconspicuous the power cord against the background of the wall by breaking up shadows that might be cast on the wall by the cord.

In one embodiment of the invention, a power cord has a sinuous shape so as to help camouflage its presence.

In one embodiment of the invention, adhesive clamps or double-sided tape may be used to hold the power cord against the wall in order to make it less conspicuous.

In one embodiment of the invention, a shock absorber is inserted in the suspension cable in case the light is dropped with slack in the cable. One option for the shock absorber is a pre-tensioned spring which requires a substantial starting force to begin stretching.

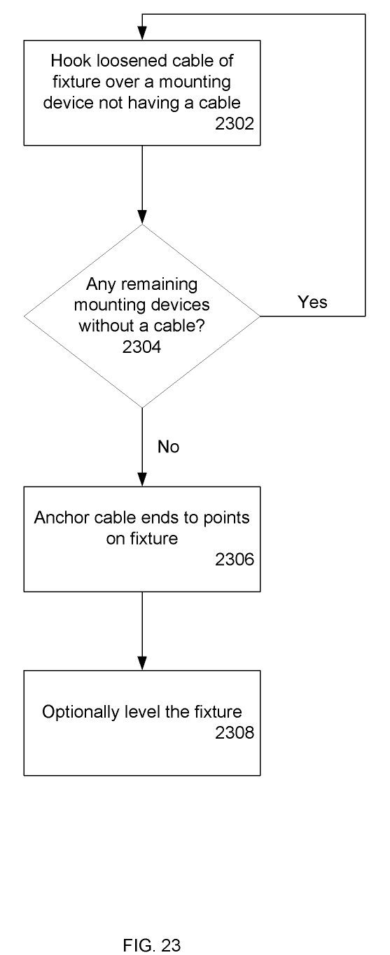

FIG. 23 illustrates one embodiment of the invention in flow chart form. At 2302 a loosened cable of the fixture is hooked over a mounting device not having a cable. At 2304 a check is made to see if any remaining mounting devices do not have a cable hooked over them. If there are more remaining with cables then repeat 2302. If all the mounting devices have cables hooked then at 2306 the cables ends of the fixture are anchored to points on the fixture. At 2308 the fixture may be optionally leveled.

In one embodiment of the invention, a cable suspension allows the cables to be unhooked and extended so the mounting loops extend above the fixture to make it easy to hook the loops on the picture hooks or mounting hooks. The mounting cable can be extended so that it reaches above the fixture making it easy to hook the cable on the wall hooks. When the cable is extended by unhooking cable ends the mounting loops can be extended until the stops engage the lower slide. The user can easily hold the fixture by the extended loops and engage the cable with the wall hooks. The cables can then be pulled and hooked, either together or to two tie points on the fixture, thus raising the fixture above the hooks. The fixture can be easily leveled by lifting one end and lowering the other end and causing the cable to move relative to the slides, changing the relative size of the mounting loops. Note that it is not essential for the cable ends to be hooked together to facilitate leveling. They can be anchored individually. The fixture stands off the wall except at either end where the end caps lie flat on the wall. The cable mounting forms an angle so as to hold the end caps flat against the wall without gapping.

While various embodiments of the invention as illustrated have shown fluorescent lights and associated devices, such as, for example a ballast, the invention is not so limited and any light source may be used and a ballast may not be needed. For example light emitting diodes may be used as a source of light and as such a ballast may not be needed. Additionally, one of skill in the art will realize that to achieve a center of gravity near the center of a light fixture not having a ballast may require that for example, a counter weight may be of uniform weight/distance or a counterweight may be adjustable to achieve a more centered center of gravity for the light fixture.

While various embodiments of the invention as illustrated have shown two access holes for assisting in hanging the fixture, the invention is not so limited and more than two access holes may be implemented in various embodiments of the invention.

While various embodiments of the invention have described an in-line power cord switch, the invention is not so limited and a power switch may be mounted on the fixture directly. For example, in one embodiment a push-on push-off switch may be mounted on the front of the fixture. In this manner the push action is against the wall thereby limiting movement of the hung fixture. In one embodiment a twist-on twist-off switch may be mounted, for example on the front, end plate, end or bottom of the fixture. In one embodiment a pull-on pull-off switch (e.g. with a pull cord) which does not require a heavy pull may be mounted on the bottom of the fixture near the middle. Additionally electronic switches such as capacitive touch switches or PIR (passive infrared) switches sensing the presence of a human or motion detection switches, etc. may be used. The power cord may be a 2-wire, 3-wire, or even a shielded power cord (no preference being given to any) and the switch may be a 1 pole, 2 pole, or 3 pole (no preference being given to any).

While various embodiments of the invention as illustrated have shown picture hooks, the invention is not so limited and any mounting may be used. For example, for a concrete wall, a expanding anchor may be used. On a movable office cubicle a cloth type anchor may be used, etc.

Other embodiments of the invention may have more than two locking positions or slots so a light fixture may be moved to a variety of positions, or it may have a locking tie point which would allow for a full range of adjustment.

Other embodiments of the invention may incorporate a built-in level, such as a bubble level or line level, as part of the fixture to assist in leveling operations.

Thus a method and apparatus for light fixture have been described.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

As used in this description, “lamp” or “light” or “fixture” or “lamp fixture” or “light fixture” or similar phrases refer to similar entities unless denoted otherwise by the language context.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

It is to be understood that in any one or more embodiments of the invention where alternative approaches or techniques are discussed that any and all such combinations as may be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus a method and apparatus for light fixture have been described.

What is claimed is:

1. An apparatus comprising:
a fixture, said fixture having a first surface, said first surface having a first cable anchor point and a second cable anchor point, said first surface having a first cable viewing hole and a second cable viewing hole; and
a cable having a first end and a second end, said cable first end attached to said first cable anchor point and said cable second end attached to said second cable anchor point, and said first cable viewing hole located proximate to said first cable anchor point, and said second cable viewing hole located proximate to said second cable anchor point such that a first portion of said cable is viewable through said first cable viewing hole and a second portion of said cable is viewable said second cable viewing hole.

2. The apparatus of claim 1 further comprising one or more cable guides, said one or more cable guides fixedly attached to said first surface and located between said first cable viewing hole and said second cable viewing hole.

3. The apparatus of claim 2 further comprising one or more cable stops fixedly attached to said cable and preventing further movement of said cable when said one or more cable stops is in contact with said one or more cable guides.

4. The apparatus of claim 2 wherein said one or more cable guides are said fixedly attached such that said cable is substantially horizontal between said one or more cable guides when a top edge of said fixture is substantially horizontal.

5. The apparatus of claim 1 further comprising a counterweight attached to said fixture wherein said attached counterweight moves the center of gravity of said fixture with respect to said fixture with said attached counterweight versus said fixture alone.

6. The apparatus of claim 5 further wherein said counterweight compensates for a weight of a fluorescent ballast attached to said fixture.

7. The apparatus of claim 6 further wherein said counterweight is angled.

8. The apparatus of claim 1 further comprising a power cord, said power cord having a break away electrical connection.

9. The apparatus of claim 1 further comprising a suspension system for said break away electrical connection such that pulling on said power cord aligns said break away electrical connection along an axis of force of said pulling on said power cord.

10. The apparatus of claim 9 wherein said suspension system further comprises a retraction mechanism such that said break away electrical connection is retracted within said fixture when said power cord is not pulled, and said break away electrical connection emerges from an edge of said fixture when said power cord is pulled.

11. The apparatus of claim 1 further comprising one or more lights, said one or more lights providing a diffuse light from one or more apertures located in said fixture onto a power cord powering said one or more lights.

12. The apparatus of claim 1 further comprising a power cord, said power cord having a sinuous shallow spiral curve.

13. A method for hanging a fixture on one or more hooks, said fixture having one or more viewing holes, and said fixture having a cable, the method comprising:
positioning said cable over said one or more hooks by viewing through one or more viewing holes.

14. The method of claim 13 wherein said fixture is raised by pulling said cable away from said fixture and said fixture is secured at a height by securing said cable to said fixture.

15. The method of claim 14 wherein said securing said cable to said fixture further comprises hooking one looped end of said cable over a slot in said fixture.

16. An apparatus comprising:
a wall mountable fixture, said wall mountable fixture having a first surface locatable proximate to a wall having one or more hooks from which said wall mountable fixture can hang;
said first surface having a cable assembly, said cable assembly having a cable having a first cable end and a second cable end;
said cable extending above said wall mountable fixture by an distance denoted as FDAF (full distance above fixture) when said first cable end and said second cable end are not secured to said wall mountable fixture.

17. The apparatus of claim 16 further comprising one or more securing points located on said wall mountable fixture, said one or more securing points wherein when said first cable end is secured to said one or more securing points said cable extending above said wall mountable fixture is a distance less than FDAF.

18. The apparatus of claim 16 wherein said first cable end is formed into a first loop and further comprising one or more hooking points located on said wall mountable fixture wherein when said first loop is hooked over said one or more hooking points said cable extending above said wall mountable fixed is a distance less than FDAF.

19. The apparatus of claim 18 wherein said second cable end is formed into a second loop and wherein when said second loop is hooked over said one or more hooking points said cable extending above said wall mountable fixed is a distance less than FDAF.

20. The apparatus of claim 19 wherein said fixture further comprises a built-in level and wherein said fixture may be raised and leveled by pulling on said first loop and said second loop and then hooking said first loop and said second loop on said one or more hooking points.
